(19) United States
(12) Patent Application Publication
(10) Pub. No.: US 2019/0130506 A1
(43) Pub. Date: May 2, 2019

(54) GRAPHICAL USER INTERFACE, APPARATUS, SYSTEM AND METHOD FOR FACILITATING THE UTILIZATION OF A REAL-TIME VALUE OF COLLATERALIZED PROPERTY IN A CENTRALIZED DATABASE

(71) Applicant: William F. Walsh, Basking Ridge, NJ (US)

(72) Inventor: William F. Walsh, Basking Ridge, NJ (US)

(21) Appl. No.: 16/177,317

(22) Filed: Oct. 31, 2018

Related U.S. Application Data
(60) Provisional application No. 62/579,801, filed on Oct. 31, 2017.

(51) Int. Cl. G06Q 50/16; G06Q 40/02; G06Q 40/06; G06F 9/451; G06F 3/0481

(52) U.S. Cl. CPC G06Q 50/163; G06Q 40/02; G06F 3/04817; G06F 9/451; G06Q 40/06

(57) ABSTRACT

A computer implemented, non-transitory, networked apparatus, method and system comprising a graphical user interface for facilitating the utilization of a real-time value of collateralized property including tracking, transforming and utilizing the real-time value of the collateralized property, including: a centralized database server for storing in structured registers data associated with collateralized property, an investment processing module networked to the database server; a display providing the graphical user interface having an investment processing module icon, and a processor that is responsive to user interaction with the investment processing module icon, opens a data register for accessing the real-time value of the collateralized property and an investment portfolio of investment vehicles which are to be or have been purchased by the user, and wherein the graphical user interface provides a function for executing a purchase of an investment vehicle utilizing at least a portion of the value of the collateralized property.

### CROSS REFERENCE TO RELATED APPLICATIONS

This application claims priority to and the benefit of U.S. Provisional Patent Application Ser. No. 62/579,801, entitled “GRAPHICAL USER INTERFACE, APPARATUS, SYSTEM AND METHOD FOR FACILITATING THE UTILIZATION OF A REAL-TIME VALUE OF COLLATERALIZED PROPERTY IN A CENTRALIZED DATABASE,” filed Oct. 31, 2017, the entirety of which is incorporated herein by reference.

### FIELD OF THE INVENTION

This invention relates generally to a graphical user interface and computerized system for facilitating the utilization of a real-time value of collateralized property including the continuous tracking, identification, valuation, revaluation, monetization, management, processing, and analysis of collateralized property, as well as the generation and management of documents and other records, securities, or other documented financial interests related thereto and the information contained therein. This invention also relates generally to the determination, processing and evaluation of the real-time value of collateralized property, and/or any other product or service on which a collateralized value may be placed. This invention further relates generally to the real-time determination, processing and evaluation of the present value of the unrealized portion of collateralized property which exceeds the unpaid amount of a related loan, and the monetization or other utilization of the value of such unrealized portion.

### BACKGROUND OF THE INVENTION

The actual collateralized value of property owned by individuals or legal entities, such as partnerships, foundations and/or corporations, is not readily available to be accessed, used or otherwise leveraged by the owner of such collateralized goods. Currently, there is no available means to utilize the accrued and/or earned value in such collateralized goods, other than possibly through refinancing the collateralized good or securing a second loan, secured by the same collateralized goods. One such example in which the current value of collateralized property may be captured and deployed for other use is present in the ownership of real property which is subject to a mortgage. In one such embodiment, a mortgage may have associated with it a fixed periodic payment made by the possessor of the collateralized property. Although each individual periodic payment may remain substantially the same until the total mortgage is fully paid, a portion of each periodic payment is allocated to payment towards a portion of the interest which has accrued on the outstanding balance of the loan, with the remainder of the periodic payment being allocated toward payment against the remaining principal and interest of the loan. Typically, such principal and interest payment allocations vary proportionately over the term of the mortgages with early payments being disproportionately allocated to interest, and later payments being almost entirely allocated to principal.

Traditional loans which are collateralized by the property which are mortgaged are typically structured such that the entirety of the collateralized goods remain completely encumbered until the entirety of the principal and any accrued interest is fully repaid to the lender. This structure does not permit the party in possession of the goods to utilize or benefit from the portion of the value of the principal and interest which has already been repaid to the lender until the loan is fully repaid. While these traditional loan repayment methods are administratively convenient for lenders, they deprive the holder of the encumbered property the benefit of access to that portion of the value of the encumbered property that has been repaid at any point in time. Furthermore, traditional methods are not capable of tracking in real-time the current value of the collateralized property thus giving a more accurate current value of the property which is not encumbered by a loan or other obligation.

Moreover, no apparatus, system and method which provides for such utilization or benefit of such repaid value is capable of tracking in real time the real-time value of the collateralized goods. In certain embodiments, the real-time value of the collateralized goods may include one or more of the actual current market value of the goods, the amount of current market value of the goods which may be currently encumbered by a loan or other obligation, and/or the amount or value of principal and interest which has already been repaid against such a loan or other obligation of the goods which may be currently encumbered by a loan or other obligation against the collateralized goods.

Thus, the need exists for an apparatus, system and method to allow for the real-time valuation, revaluation and/or monetization of the portion of the principal and interest of such a loan which has already been repaid to a lender, and thus takes into account and allows for the actual current value of the unencumbered portion of the collateralized goods to be utilized or otherwise benefitted from prior to the repayment of the entirety of the principal and interest. There also exists the need for such an apparatus, system and method to allow for the real-time valuation, revaluation and/or monetization of the collateralized goods for use in such an apparatus, system and method. The need also exists for such an apparatus, system and method which also facilitates the generation and management of documents and other records related thereto and the real-time valuation of the collateral available and other information associated with the property.

### SUMMARY OF THE INVENTION

The present invention relates to a system comprising a graphical user interface for tracking and transforming collateralized property and related obligations, including: a centralized database server for storing in structured registers data associated with collateralized property, a borrowing and investment processing module networked to the database server; a display providing the graphical user interface having an investment processing module icon, and a processor that is responsive to user interaction with the borrowing and investment processing module icon, opens a data register for accessing the calculated value (which calculated value may be calculated substantially in real time) of the collateralized property and a borrowing and investment portfolio of investment vehicles which are to be or have been purchased by the user or a third party for the benefit of the user, and wherein the graphical user interface provides a function for executing a purchase of an investment vehicle utilizing at least a portion of the value of the collateralized property.

In certain embodiments, the system, apparatus and method of the instant invention may comprise a user interactive or other automated system, such as a computerized system, which utilizes the input or acquisition of data from one or more sources. Such data may be input to the system of this invention through one or more computerized input/output devices such as computer terminals, servers, laptop computers, smart tablets, smart phones, or other portable or non-portable electronic devices.

The data may then be analyzed, transformed, or otherwise processed via one or more computerized processing devices, each of which may comprise both a computer processor and associated software which includes instructions for appropriate processing of such data.

The input and processed data may also be stored in accordance with the system, apparatus and method of this invention in one or more storage devices, such as computer memory devices, for archiving and later retrieval by the system of this invention for further processing and/or as output data generated by the computerized system. Output data may also be stored in one or more such storage devices for archiving and later retrieval, further processing, and/or as output data generated by the computerized system of this invention.

Also, it should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Data input to, processed by, or output from the system of this invention may be retrieved by users of the system and apparatus of this invention through one or more computerized input/output devices such as computer terminals, servers, laptop computers, smart tablets, smart phones, or other portable or non-portable electronic devices.

The system and method of the instant invention may also be carried out via computerized systems which may be accessed either through closed architecture computerized systems such as, for example, client and server computer networks, and/or through open architecture computerized systems such as, for example, web-based portals accessed via the Internet.

In certain embodiments the apparatus, system and method provide for the utilization or benefit of the repaid value of the principal and any accrued interest by tracking in real time the actual repaid value of the principal and any accrued interest, and/or the current and/or real-time value of the collateralized goods. In certain embodiments, the real-time value of the collateralized goods may include one or more of the actual current market value of the goods, the amount of current market value of the goods which may be currently encumbered by a loan or other obligation, and/or the amount or value of principal and interest which has already been repaid against such a loan or other obligation of the goods which may be currently encumbered by a loan or other obligation against the collateralized goods.

The system and method of the instant invention may also process though computerized and/or other automated systems, such as for example, a computerized management module, the real-time present value of the unrealized portion of collateralized property which exceeds the unpaid amount of a related loan associated with the collateral property, and the monetization or other utilization of the value of such unrealized portion. In certain embodiments, the unrealized portion of the value of the collateralized property may be displayed on a graphical user interface in real time and in various colors and/or emitting sounds or other indications to the user that there exists an excess or unrealized portion of the value of the collateralized property at which point the system may automatically, or semi-automatically with the assistance of a user, process though a computerized investment module such unrealized portion for investment in an investment vehicle. Such investments, their trade status, present value, and other information pertinent to each investment made may be displayed to a user in real-time on a display in operative communication with the system.

The system employed such embodiments may carry out such real-time processing at speeds which enable the present unrealized value of the collateralized property to be captured in real-time and then are efficiently invested in investment vehicles at predetermined values of the investment by, for example, presetting buy/sell limits in order to enable the efficient purchase or sale of such investment vehicles in accordance with an overall investment strategy. Thus, the system may insure that appropriate investment vehicles are bought and sold at optimal times in rapidly changing markets which otherwise would not be possible by conventional means.

Thus, the need exists for an apparatus, system and method to allow for the real-time valuation, revaluation and/or monetization of the portion of the principal and interest of such a loan which has already been repaid to a lender, and thus takes into account and allows for the actual current value of the unencumbered portion of the collateralized goods to be utilized or otherwise benefitted from prior to the repayment of the entirety of the principal and interest. There also exists the need for such an apparatus, system and method to allow for the real-time valuation, revaluation and/or monetization of the collateralized goods for use in such an apparatus, system and method. The need also exists for such an apparatus, system and method which also facilitates the generation and management of documents and other records related thereto and the real-time valuation of the collateral available and other information associated with the property.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, in which like numerals refer to like parts, and wherein:

FIG. 1 is a diagram illustrating an embodiment of the system and architecture of the creation of a master document via Document Data Files and related Data Registers;

FIG. 2 illustrates an embodiment of a scenario simulator;

FIG. 3 illustrates an embodiment of another scenario simulator;

FIG. 4 illustrates an embodiment of another scenario simulator;

FIG. 5 is a diagram illustrating an embodiment of user access to the database server;

FIG. 6 is a diagram illustrating an embodiment of a system for utilizing a graphical user interface for structuring, accessing and processing data in a centralized database server; and

FIG. 7 is diagram illustrating an embodiment of a system for tracking and transforming collateralized property through a centralized database server.

EXHIBIT A comprises additional information related to the present disclosure, and is incorporated herein by reference.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An embodiment addresses the issues of continuous tracking, identification, valuation, revaluation, monetization, management, processing, and analysis of collateralized goods, as well as the generation and management of documents and other records related thereto and the information contained therein. As will become more apparent in the description of exemplary embodiments, the discussed technological improvements offered by the various embodiments are applicable to a large variety of collateralized goods which are subject to a first loan, transforming the present value of the collateralized goods for another intended use and generating various documentation related to the utilization of the present value of such collateralized goods.

Although various example embodiments are described with a focus on investment enterprise applications (e.g., lending and investment related to collateralized assets and contracts), the principles and technological improvements offered may likewise be applied to various applications (e.g., of manufacturing companies, real estate companies, health care companies, transportation companies, financial companies, etc.) Thus, embodiments permit enterprises as well as individuals to improve the efficiencies in the creation and management of information modules (e.g., data fields, memory registers, etc.), graphical user interfaces, and computer processors for rapid data tracking and transformation. Embodiments may also be applied in contexts other than the generation of investment and loan documents for enterprises as well as individuals (e.g., asset management documents, present and historical valuation reports, advertising distribution, disclosure document creation, etc.)

It is generally difficult to create and track certain documents related to multiple loans all associated with a single collateralized property which also incorporates real time information where the valuation of the collateralized property, interest rates, principal amounts, and the like constantly varies during the course of the ownership of collateralized property. Because of the number and variation in these documents, the total number and scope of these documents and their relationship to on another may quickly become difficult to manage. Thus, a system is needed to manage these variations (e.g., principal, interest, loan rate based modules) and allow for ease in searching (e.g., by keyword, collateralized property identification, loan identification number, borrower and lender name, etc.) and tracking. Not only may there be a broad range of diverse information, but the information may require modifications in order to meet the needs of a particular issue. Traditionally, loan companies, such as banks, have drafted these types of loan contract documents with conditional logic (e.g., if/then statements) to generate contract language that complies with the banking regulations of each of the states where the contract may be issued.

However, this manual method is not only inefficient, it may be nearly impossible to execute transactions in a timely manner to meet market demands and changes such as loan interest rate fluctuations and volatile swings in the valuation of the underlying collateralized property, leading to possible unintended consequences. Thus, a solution is needed to manage and track the components and underlying information related to the coordination of the many relationships, rights and obligations embedded in the contracts associated with the collateralized property.

Creating, tracking and managing such documents as well as the interrelationships between the documents requires constant monitoring and assessment of critical data registers and information modules across multiple documents. The process of monitoring and assessment may likely involve input from individual users in different roles who have a need to access only certain information related to the collateralized property, its valuation and assets associated with such collateralized property (e.g., agencies, lenders, borrowers, broker-dealers, investors, financial consultants, IT administration, legal advisors, etc.). Thus, an embodiment may provide a solution that may track and maintain a numerous data fields and registers across many documents as well as control the access to and modification of such data fields and maintain a history of such access, all of which may be essential to the disposition of the collateralized property.

In view of the foregoing, an embodiment utilizes a web based system which enables the interactive creation, tracking and management of documents as well as the interrelationships between the various documents which enables the valuation and monetization of collateralized goods. This functionality entails the resolution of technical issues regarding the continuous creation, tracking and management of the collateralized property in real time. An embodiment also provides users with the documentation necessary to manage the relationships, rights and obligations between multiple parties interested in the disposition of the collateralized property.

An embodiment improves the overall management and disposition of the collateralized property discussed herein, enhances tracking, analysis and reporting related thereto, allows for real time access of current information related to the collateralized property (e.g. current value of the collateralized property, loan interest rates, secured interests against the collateralized property) as well as the creation, tracking and management of documentation related to the collateralized property. Thus, an embodiment provides a definitive state of the collateralized property at any given point in time, provides an automated system which comprises the data files and registries interacting through computerized processors acting through a graphical user interface to create accurate and timely documents related to the collateralized property.

Embodiments represent a significant technical improvement to the real time registries and data files related to the collateralized property through an enhanced graphical user interface. An embodiment is directed to substantially more than merely a computer implementation of a routine or conventional activity previously known in the industry as it significantly advances the technical efficiency, access and/or accuracy of creating, maintaining, tracking, and storing unrelated data files and registries by the implementation of a specific new system and method as defined herein.

An embodiment provides a specific advancement in the area of real time data compilation, tracking, storage, access and management for complex assets (e.g., collateralized property), by providing technical benefits for registry and data file creation, integration of disparate systems, and creation, tracking, storage, analysis and management of documentation associated with such complex assets. Such advances are not merely a longstanding commercial practice. The embodiments provide improvement beyond a mere generic computer implementation as they involve the processing and conversion in real time of significant amounts of data in a new beneficial manner as well as the interaction of a variety of specialized asset, client and/or vendor systems, networks and subsystems.

For example, an embodiment facilitates the efficient management of a centralized data file module. By creating, managing, tracking individual document data files and registries containing specific data registries of information specific to each document data file from document data file creation and providing the functionality to interrelate the data registries between individual documents data files, the embodiment fills an immediate and longstanding need for owners of valued assets such as collateralized property. In addition, the centralized data file module allows for the real time intervention by a particular individual or application for the systematic modification of document data files related to the valued asset if preset limits or other deficiency in data registries are out of range (e.g. valuation of asset is outside an allowable range). The correction process is also efficiently implemented, tracked and adjusted in real time. While multiple parties may be involved with such a correction process (e.g. lenders, borrowers, asset managers, broker-dealers, etc.) may be involved at different points in the process, the correction process is continuous and non-disruptive during each phase of the correction.

The correction process may be continuous and non-disruptive because an embodiment stores all the information in a centralized database. Changes to document data files and data registries are centrally controlled although numerous users with various levels of permissions may have access to certain portions of the centralized database. There is no need to replicate changes in different document data files or registries because a change to one data file or registry will be implanted in real time and may implement related changes to other related document data files or registries, also in real time. Therefore, continuity in data accessible to all users is maintained in real time and the potential for user error from any source is reduced or eliminated.

The embodiments illustrated herein may be best understood by reference to the figures. The following description is intended only by way of example, and simply illustrates certain exemplary embodiments.

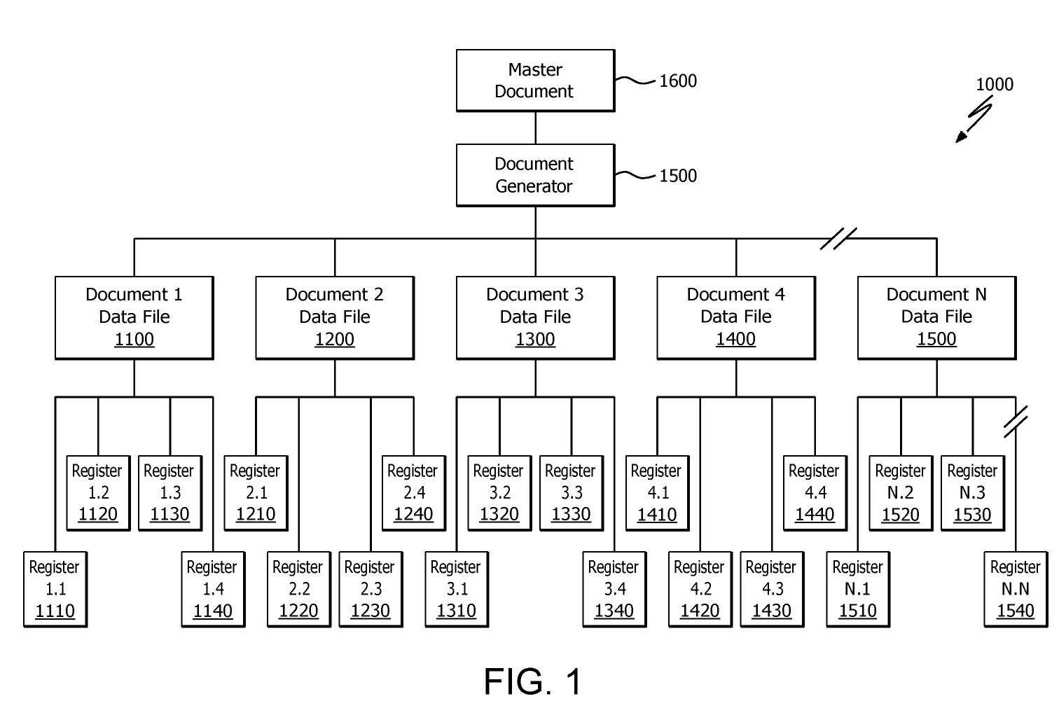

Referring now to FIG. 1, there is shown Master Document Generator Module 1000 which may produce Master Document 1600. Master Document Generator Module 1000 may comprise a configuration of Document Data Files 1100, 1200, 1300 and 1400, and Data Registers 1110, 1120, 1130, and 1140, each corresponding to Document Data File 1100, Data Registers 1210, 1220, 1230, and 1240, each corresponding to Document Data File 1200, Data Registers 1310, 1320, 1330, and 1340, each corresponding to Document Data File 1300, and Data Registers 1410, 1420, 1430, and 1440, each corresponding to Document Data File 1400.

In an embodiment, Master Document Generator Module 1000 may further comprise Document Aggregator 1500 which accesses one or more of the Document Data Files and Data Registers and processes retrieved data to produce Master Document 1600. In an embodiment, Document Aggregator 1500 may comprise a website or program that collects related items of content (such as, by way of nonlimiting example, the Document Data Files and Data Registers discussed herein), and displays such items or links to such items.

Any number of Document Data Files and Data Registers may be configured to suit the intended purpose and functionality of Master Document Generator Module 1000, as depicted by Document Data File 1400 (i.e. “Document N Data File”), and Data Registers 1410, 1420, 1430, and 1440 (i.e. “Data Register N.N”).

In an embodiment, each Document Data File and corresponding Data Registers may comprise data related to an individual document such as, for example, a loan agreement or property valuation report related to collateralized property. Accordingly, multiple documents and their related data may then be associated with the collateralized property by utilizing Master Document Generator Module 1000.

For example, Document Data File 1100 may be assigned to a first collateralized loan agreement associated with defined collateralized property. Data Register 1110 may be populated with the name of the lender, Data Register 1120 may be populated with the name of the borrower, Data Register 1130 may be populated with the term of the loan, Data Register 1140 may be populated with the interest rate on the loan, Data Register 1150 may be populated with the amount of principal and interest paid on the loan to date, and Data Register 1160 may be populated with the amount of principal and interest paid which is currently encumbered by another loan or other asset.

Similarly, Document Data File 1200 may be assigned to a first investment loan agreement collateralized by principal and interest payments which have been made under the first collateralized loan agreement assigned to Document Data File 1100. Data Register 1210 may be populated with the name of the lender, Data Register 1220 may be populated with the name of the borrower, Data Register 1230 may be populated with the term of the first investment loan, Data Register 1240 may be populated with the interest rate on the first investment loan, Data Register 1250 may be populated with the amount of principal and interest paid on the first investment loan to date, Data Register 1160 may be populated with the amount of principal and interest paid which is currently encumbered by another loan or other asset, and Data Register 1260 may be populated with data related to the value of investments which have been paid for by proceeds of the first investment loan.

Likewise, Document Data File 1300 may be assigned to a second investment loan agreement collateralized by principal and interest payments which have been made under the first collateralized loan agreement assigned to Document Data File 1100. Data Register 1310 may be populated with the name of the lender, Data Register 1320 may be populated with the name of the borrower, Data Register 1330 may be populated with the term of the second investment loan, Data Register 1240 may be populated with the interest rate on the second investment loan, Data Register 1250 may be populated with the amount of principal and interest paid on the second investment loan to date, Data Register 1160 may be populated with the amount of principal and interest paid which is currently encumbered by another loan or other asset, and Data Register 1360 may be populated with data related to the value of investments which have been paid for by proceeds of the second investment loan.

Additional Document Data Files and Data Registers may be added in an embodiment to accommodate the number of documents and the data necessary to fulfill the functionality of Master Document Generator Module 1000. For example, data related to additional investment loan agreements may be added to Master Document Generator Module 1000 by including additional Document Data Files and associated Data Registers for each such loan.

In an embodiment, Master Document 1600 may comprise, at least some data retrieved from the Document Data Files and/or Data Registers and aggregated by Document Aggregator 1500. Also, Master Document Generator Module 1000 may be all or partially a web based, enterprise based and/or networked based computerized system.

Once the parameters of Master Document 1000 are determined, the information required from various sources (such as, for example, information contained in one or more individual documents) to create Master Document 1000 are identified as well as the information to be required from each source. The system architecture necessary to accommodate the production of Master Document 1000 may then be configured.

For example, if Master Document 1000 requires data from three different sources (e.g. documents, outside databases, etc.) three Document Data Files 1100, 1200 and 1300 may be configured with Data Registers 1110 through 11N0, 1210 through 12N0, and 1310 through 13N0, respectively, where N is the number of Data Registers necessary to accommodate the various data required to be accessed from each of the Document Data Files to enable the production of Master Document 1000. In addition, the production of Master Document 1000 may not necessarily require all of the data available from each individual source in any particular configuration.

Once the architecture is completed, each Document Data File and corresponding Data Register(s) may be populated with the appropriate data from that information source. In an embodiment, one or more Document Data Files and/or Data Registers may be populated from sources which provide real-time data required to produce Master Document 1000.

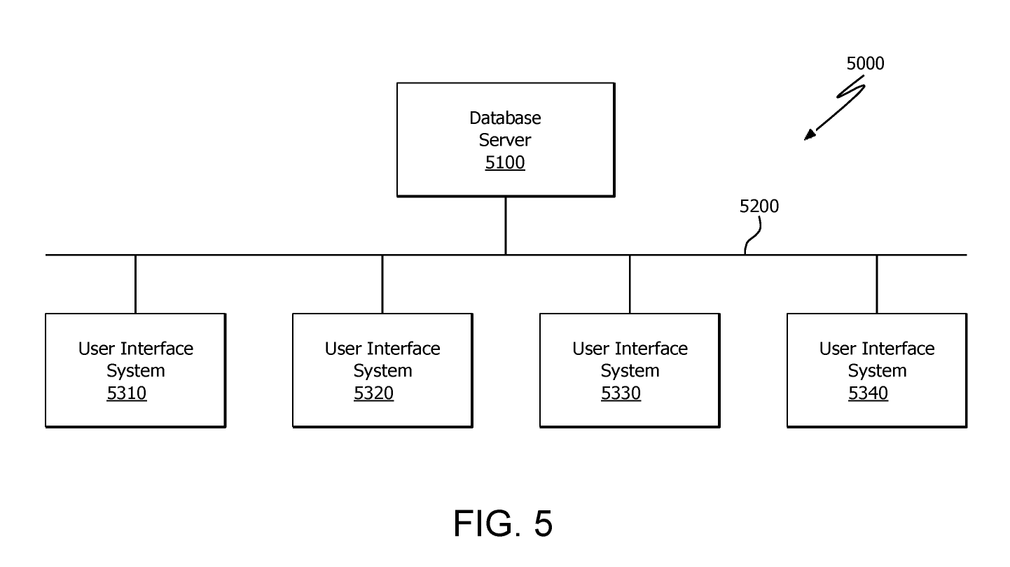

Additionally, an embodiment may store the Document Data Files and/or Data Registers in a Database Server discussed in further detail herein (such as, for example, Database Server 5010 depicted in FIG. 5). Such a Database Server may be maintained independently by a third party (e.g., cloud server service), stored and maintained locally, or by other suitable storage configuration. Although a single server may be employed, multiple servers may also be incorporated. Moreover, multiple databases on multiple systems may be utilized to host the Document Data Files and/or Data Registers. For example, in an embodiment, the systems may categorized by data type or source (e.g., lending category, investment category, institution category, etc.).

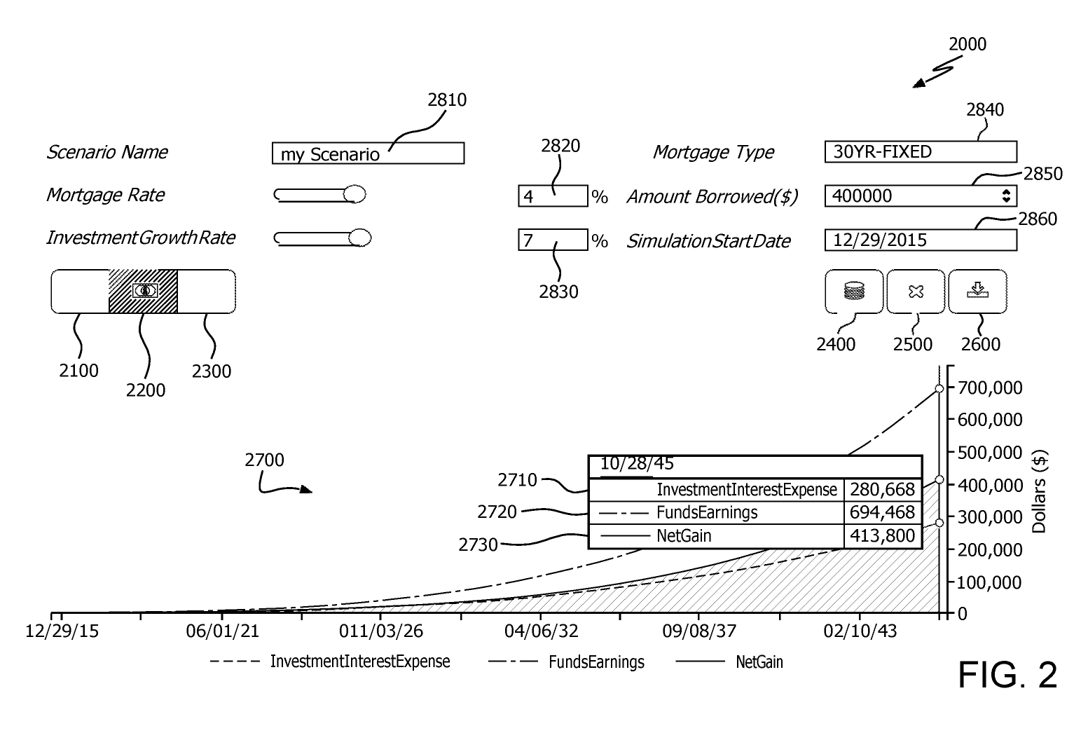

A graphical user interface (also referred to herein as “GUI”), may be integrated in an embodiment, such as, for example, the Graphical User Interfaces depicted in FIGS. 2, 3 and 4. One or more Graphical User Interfaces may in operative communication with a database which hosts the Document Data Files and/or Data Registers from which data associated with the monetization of collateralized property owned by a borrower under a first loan collateralized by the property may be configured, entered, retrieved, searched, tracked, and/or otherwise transformed. For example, the Graphical User Interface(s) may be in operative communication via a wired network, a wide area network (“WAN”), local area network (“LAN”), or other suitable communication configuration.

The Graphical User Interface may also comprise one or more icons for accessing a home and/or sub-screens, which provides access to some or all of the functionality of the system. From the home or a sub-screen of an embodiment, data may be input, saved, and/or or retrieved from the Document Data Files and/or Data Registers maintained in the Database Server by the actuation of one or more icons and/or other control devices. In addition, data may be searched, tracked and/or transformed in accordance with the functionality of the system. Moreover, external systems and databases may be accessed through the Graphical User Interface.

In an embodiment, the system may comprise a Graphical User Interface and one or more Database Servers for storing in a Data Register associated with at least one of the Document Data Files, one or more of a value equal to an amount of available principal and interest accrued from principal and interest paid against a first collateralized loan and, and a value equal to an amount of available funds of a first investment loan. In this regard, the amount of available funds from the first investment loan may be based upon the principal and interest which has been paid against the first collateralized loan.

The system may also comprise an Investment Module which is in operative communication with the Database Server, as well as a Display Device, such as, for example, a computer terminal. The Display may provide a Graphical User Interface which may be in operative communication with the Investment Module which may permit access by a user of the system to the Investment Module, through the Graphical User Interface.

The system may further comprise a Processor which may be responsive to user interaction with the Investment Module through one or more icons or other responsive device to access, among other functionality, a selection of one or more investment vehicles. In an embodiment, such interaction may open a data field which indicates an amount of each investment vehicle which is to be purchased by the user. Moreover, the graphical user interface may provide a function for executing the purchase of the amount of each investment vehicle which may be purchased using at least a portion of the funds available from the second investment loan.

In an embodiment of the Graphical User Interface and associated system, an interest-bearing first collateralized loan may be taken by an individual borrower to be used for the purchase of a collateralized asset, such as real property. The lender may take a security interest in the collateralized asset to secure the payment of the first loan. The borrower is obligated to make periodic payments which may be calculated by determining how much principal and interest should be paid each period. In certain embodiments, the periodic payments made are of the same or substantially the same amount, however, the amount of principal paid is incrementally increased each period, while the amount of interest paid decreases.

Periodic payments are made until there is no more principal and interest to be paid by the time the first collateralized loan is set to expire. Thus, each periodic payment may comprise a portion applied to the outstanding principal of the first collateralized loan, with the remaining portion of the payment applied to interest which has accrued on the first collateralized loan. Because each periodic payment remains substantially the same throughout the payback period of the first collateralized loan, the first collateralized loan may also be structured so that slightly more principal, and slightly less interest, is paid with each successive payment until the first loan, together with all accrued interest, is fully paid back to the lender.

In certain embodiments, all or a portion of the current or projected value of the periodic principal and/or interest payments being made by the borrower on the first collateralized loan may be scheduled in advance to be used and/or dynamically calculated or recalculated based upon loan level factors and/or dynamically calculated and/or recalculated based upon exogenous, third-party, pool, or portfolio related factors and released upfront and/or over time and subsequently used (as, for example, by the recipient entitled to ultimately receive the principal and interest payments) to secure a first investment loan. The first investment loan may in an embodiment carry the same or similar interest rate as the first collateralized loan, or another interest rate and/or in certain embodiments the first investment loan may be collapsed within the first collateralized loan wherein the investments are added as collateral to the collateral of the first collateralized loan and the interest rates loan amounts may or may not be aggregated.

In certain embodiments, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future used (as, for example, by the recipient entitled to ultimately receive the principal and interest payments) to secure a first investment loan. The first investment loan may in an embodiment carry the same or similar interest rate as the first collateralized loan, or another interest rate and/or in certain embodiments may be collapsed within the first collateralized loan whereby the investments are added to the collateral of the first investment loan and the rates loan amount may or may not be aggregated.

Alternatively, in an embodiment, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future be held (as, for example, by the recipient entitled to ultimately receive the principal and interest payments) in a designated account held by the borrower of the first collateralized loan by a third party in a designated or general account at least partially for the benefit of the borrower, and to be used only for the purpose of investing in select assets.

Alternatively, in certain embodiments, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future be held (as, for example, by the recipient entitled to ultimately receive the principal and interest payments) within a security, debt instruments, exchange traded funds, mutual funds, hedge funds, REITS, insurance contracts, or the combination thereof through reference agreements by the borrower of the first collateralized loan or by a third party or sold to a third party or parties to be used for the purpose of investing in select assets whose value will accrue at least partially for the benefit of the borrower of the first collateralized loan.

In an embodiment, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future be held (as, for example, by the recipient entitled to ultimately receive the principal and interest payments) within a security, debt instruments, exchange traded funds, mutual funds, hedge funds, REITS, insurance contracts, or the combination thereof through reference agreements by the borrower of the first collateralized loan or by a third party or sold to a third party or parties to be used as collateral by the third party to secure a second collateral loan to generate to generate additional value for the purpose of investing in select assets whose value will accrue at least partially for the benefit of the borrower of the first collateralized loan.

In an embodiment, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future be held (as, for example, by the recipient entitled to ultimately receive the principal and interest payments) within a security, debt instruments, exchange traded funds, mutual funds, hedge funds, REITS, insurance contracts, or the combination thereof through reference agreements by the borrower of the first collateralized loan or by a third party or sold to a third party or parties to be used as collateral by the third party in addition to securing a second collateral loan or collateral agreement based upon at least a portion of the future excess collateral within the first collateralized loan. The cost of the second collateral loan or collateral agreement may in an embodiment be at least partially offset through the use of the first collateralized loan or security interest for the purpose of investing in select assets whose value will accrue at least partially for the benefit of the borrower of the first collateralized loan.

In an embodiment, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future be held (as, for example, by the recipient entitled to ultimately receive the principal and interest payments) within a security, debt instruments, exchange traded funds, mutual funds, hedge funds, REITS, insurance contracts, or the combination thereof through reference agreements by the borrower of the first collateralized loan or by a third party or sold to a third party or parties to be used as collateral by the third party in addition to securing a second collateral loan or collateral agreement based upon at least a portion of the future excess collateral within the first collateralized loan. At least a portion of the second collateral loan or collateral agreement may in an embodiment be used for the purpose of investing in select assets whose value will accrue at least partially for the benefit of the borrower of the first collateralized loan.

In an embodiment, all or a portion of the current or projected value of the periodic principal and/or interest payments being made by the borrower on the first collateralized loan may be scheduled in advance to be used and/or dynamically calculated and/or recalculated based upon loan level factors and/or dynamically calculated and/or recalculated based upon exogenous portfolio related factors and released upfront and/or over time and and/or a portion of the current value of the excess collateral defined within the first collateralized loan may upon closing of the first collateralized loan or at an undetermined time in the future be held (as, for example, by the recipient entitled to ultimately receive the principal and interest payments) within a security, debt instruments, exchange traded funds, mutual funds, hedge funds, REITS, insurance contracts, or the combination thereof through reference agreements by the borrower of the first collateralized loan or by a third party or sold to a third party or parties to be used as collateral by the third party in addition to securing a second collateral loan or collateral agreement based upon at least a portion of the future excess collateral within the first collateralized loan. At least a portion of the second collateral loan or collateral agreement may in an embodiment be used for the purpose of reducing other obligations related to the first collateralized loan the value of which will be used to invest in select assets whose value will accrue at least partially for the benefit of the borrower of the first collateralized loan.

In an embodiment, the borrower or third party may then use the money borrowed through the first investment loan, or through a designated account, to invest in revenue generating or appreciating asset vehicles. Such investment vehicles may include, but not be limited to, investments in financial market instruments, securities, equity, debt instruments, mutual funds, hedge funds, REITS, insurance contracts or the combination thereof through reference agreements, possibly including a combination that may or may not contain financial interests in the first collateralized loan and or other similar or unrelated assets.

In an embodiment which has a borrower or a third party taking a first investment loan, the principal and interest payments made on the first collateralized loan build equity in the collateralized asset, such as real property and/or securities tied to the property, as the proceeds of that principal and interest payment is then lent back to a borrower or third party via a first investment loan, provided that the borrower or third party invests the proceeds of the first investment loan in designated investment vehicles. The first investment loan may be collateralized by the value of the investment vehicles held in a borrower's Investment Portfolio Account, and/or in certain embodiments by at least a portion of the value of the investment loan and/or securities tied to the collateralized property.

In an embodiment which has a borrower or a third party taking a first investment loan, the principal and interest payments made on the first collateralized loan build equity in the collateralized asset, such as real property and/or securities tied to the property, as at least a portion of the proceeds of that principal and interest payment is then lent back or otherwise used by the borrower, a purchaser, or third party via a first investment loan or use of dedicated funds having outside ownership interest in the funds, provided that the borrower or third party invests at least a portion of the proceeds of the first investment loan or investment interest in designated investment vehicles. The first investment loan may be collateralized by the value of the investment vehicles held in a borrower's Investment Portfolio Account, and/or in certain embodiments by at least a portion of the value of the investment loan and/or securities tied to the collateralized property.

In an embodiment the borrower or a third party uses a portion of the current or projected future value the principal and interest payments made on the first collateralized loan in the collateralized asset, such as real property and/or securities tied to the property, such that the value of that principal and interest payment is then granted to a third party via a first investment loan or use of dedicated funds having outside ownership interest in the funds, provided that third party invests the value of the first investment loan into the first investment loan in designated investment vehicles. The first investment loan or investment interest may be collateralized by the value of the investment vehicles held in a borrower's Investment Portfolio Account, and/or in certain embodiments by at least a portion of the value of the investment loan and/or securities tied to the collateralized property.

In an embodiment the borrower or a third party uses a portion of the current or projected future business, marketing and transaction value of the principal and interest payments made on the first collateralized loan in the collateralized asset, such as real property and/or securities tied to the property, such that the value of that principal and interest payment is then granted to a third party via a first investment loan or use of dedicated funds having outside ownership interest in the funds, provided that third party invests the value of the first investment loan into the first investment loan in designated investment vehicles. The first investment loan or investment interest may be collateralized by the value of the investment vehicles held in a borrower's Investment Portfolio Account, and/or in certain embodiments by at least a portion of the value of the investment loan and/or securities tied to the collateralized property.

In an embodiment a third party uses a portion of the current or projected future value the principal and interest payments made on the first collateralized loan in the collateralized asset, such as real property and/or securities tied to the property, such that the designated portion of value of that principal and interest payment from other first collateralized loans controlled by the third party and who have already received their benefit is then granted to a third party via a first investment loan or use of dedicated funds having outside ownership interest in the funds, provided that third party invests the value of the first investment loan into the first investment loan or investment interest in designated investment vehicles. The first investment loan or investment interest may be collateralized by the value of the investment vehicles held in a borrower's Investment Portfolio Account, and/or in certain embodiments by at least a portion of the value of the investment loan and/or securities tied to the collateralized property.

In an embodiment a third party uses a portion of the current or projected future value the principal and interest payments made on the first collateralized loan in the collateralized asset, such as real property and/or securities tied to the property, such that the designated portion of value of that principal and interest payment from other first collateralized loans controlled by the third party and who have already received their benefit is then granted to a third party via a first investment loan or use of dedicated funds having outside ownership interest in the funds, provided that third party invests the value of the first investment loan into the first investment loan or investment interest in designated investment vehicles. The first investment loan or investment interest may be collateralized by the value of the investment vehicles held in a borrower's Investment Portfolio Account, and/or in certain embodiments by at least a portion of the value of the investment loan and/or securities tied to the collateralized property and/or in certain embodiments the collateralized value of the investment vehicles held in a borrower's Investment Portfolio Account can be used for a second investment loan or obligation to be used to purchase or otherwise accept additional investment exposure to instruments held in the investment portfolio.

In certain embodiments wherein the borrower or third party in possession of the first collateralized asset receives some portion of the benefit of a designated account derived from the first investment loan, the principal and interest payments made on the first collateralized loan may build equity in the collateralized asset, such as real property, as the proceeds of that principal and interest payment are received by the party ultimately entitled to receive the proceeds are invested in designated investment vehicles. The value of the designated account is secured by the value of the investment vehicles held in the designated account, at least a portion of which is designated to the borrower.

Hence, the collateralized asset which is the subject of the first collateralized loan is protected, and that portion of the value of the first investment loan is collateralized by the present value of the investment vehicles and/or the present value of securities tied to the collateralized property, or in some embodiments, a portion of the dollar value of the first investment loan held in the borrower's or third party's Investment Portfolio Account, and/or that portion of the value of the designated custody account, and/or may be secured by the present value of the investment vehicles, a portion of which may be designated for the benefit of the borrower of the first collateralized loan. Thus, as principal and interest payments are made on the first collateralized loan, equity is built in the collateralized asset and/or securities tied to the collateralized property, while all or a portion of the current or projected value of the principal and interest payments being made on the first collateralized loan is released upfront or over time to an Investment Portfolio Account for investment via the granting of the first investment loan or, in certain embodiments, the granting of the value to the designated custody account or other security, debt instruments, exchange traded fund, mutual funds, hedge funds. REITS, insurance contract or the combination thereof through reference agreements issue or purchased by a third party. In an embodiment, the resulting Investment Portfolio Account, or a portion of the value of the designated custody account or other security, debt instruments, exchange traded fund, mutual funds, hedge funds. REITS, insurance contract or the combination thereof through reference agreements issue or purchased by a third party, of which the borrower of the first collateralized loan is the beneficiary, may be managed through an Investment Management Module.

In certain embodiments, the value of the investments and proceeds held in the Investment Portfolio Account or the like which accumulate during the term of the first collateralized and first investment loans, may be protected by various means. For example, embodiments may provide that if, at any time, the present value of the Investment Portfolio Account were to fall by more than a predetermined percentage below the initial investments made into the Investment Portfolio Account, one or more of the first and/or subsequent investment loans could be called back by the lender, and the predetermined percentage below the initial investments, or other loss, may be absorbed by protective investments placed on by a third party on behalf or for the benefit of the borrower.

In certain embodiments, the value of the investments and proceeds held in the Investment Portfolio Account which accumulate during the term of the first collateralized and first investment loans, may be held by a third party borrower that assumes the risk of the initial investments made into the Investment Portfolio but may, on a contingent basis, pass a portion of the excess returns to the borrower of the first collateralized loan.

Also, in certain embodiments, the value of the investments and proceeds held in the Investment Portfolio Account which accumulate during the term of the first collateralized and first investment loans, may be held by a third party borrower that assumes the risk of the initial investments made into the Investment Portfolio but may, on a contingent basis, pass total value of the proceeds held in the Investment Portfolio Account which accumulate during the term of the first collateralized and first investment loans less the cost of the first investment loans to the borrower of the first collateralized loan.

In certain embodiments, the value of the investments and proceeds held in the Investment Portfolio Account which accumulate during the term of the first collateralized and first investment loans, may be held by a third party borrower that assumes the risk of the initial investments made into the Investment Portfolio but may, on a contingent basis, pass total value of the proceeds held in the Investment Portfolio Account which accumulate during the term of the first collateralized and first investment loans less the cost of the first investment loans and a predetermined maximum contingent cash benefit to the borrower of the first collateralized loan.

In certain embodiments, the first investment loan may be directly tied to payments made by the borrower on the first collateralized loan as the receiver of the payments made by the homeowner subsequently lends a portion of the value of the payment to the entity receiving the first investment loan.

In certain embodiments, the first investment loan may be indirectly tied to payments made by the borrower on the first collateralized loan as the receiver of the payments made by the homeowner are subsequently placed into a security or other such financial arrangement and sold to an investor in the security which subsequently lends a portion of the value of the payment to the entity receiving the first investment loan.

In certain embodiments, the first investment loan may be approximately tied to payments made by the borrower on the first collateralized loan as the receiver of the payments made by the homeowner, or other possessor of the collateral, are approximately reflected within a security or other such financial arrangement and purchased by an investor in the security which subsequently lends a portion of the value of the payment to the entity receiving the first investment loan.

In certain embodiments, the first investment loan may be indirectly or approximately tied to payments made by the borrower on the first collateralized loan as the receiver of the payments made by the homeowner are valued and sold to a third party or placed into a security or other such financial arrangement. A portion of the current proceeds of the calculated future value of the principal and interest payments and subsequently sold to an investor in the security which subsequently uses the collateral on that security to borrow additional securities subsequently lends a portion of the borrowed value of the payment to the entity receiving the first investment loan.

In certain embodiments, the system may employ the principals of long-term compounding growth, and given that the borrower of the first collateralized loan may otherwise satisfy the interest rate on the first investment loan secured by the value of the investments made with the first and/or subsequent investment loan amounts, the overall increase in value of the investments will accrue to the benefit of the borrower of the first collateralized loan.

In certain embodiments, the system may employ the principals of long-term compounding growth, and given that the borrower may obtain an interest rate on the first investment loan that is the same or nearly the same of the original first collateralized loan, (that is, the optimal rate), the first investment loan is secured by the value of the investments made with the first and/or subsequent investment loan amounts, as if the investment loan(s) were secured by the collateralized property. If the overall value of the investments falls below an established level, the first investment loan may be called back by the lender. However, in the event of such a call, the borrower would not owe the lender the value lost from the investments, and the borrower may ultimately keep the original first collateralized loan, and the equity earned in the collateralized property.

In certain embodiments, the system may employ means to define the parameters of the collateral, the sought first collateral loan parameters, and the sought first investment loan parameters, including sought economics, and the means to choose and to display all or none of the parameters to a select group, registered users of the system, or to the general public for the purpose requesting offers for each loan component or all in a package.

In certain embodiments, the system may employ means to communicate with selected parties, based upon selected criteria.

In certain embodiments the system may employ means to display the correct amount of information to the correct parties at the correct time through a defined release protocol.

In certain embodiments employed means of information release may release information based upon a defined hierarchy by the system administrator and/or upfront by the holder of the collateral or the issuer of prospective issuer of the first collateralized loan or the issuer of the first investment loan and/or dynamically as the parties choose to release information and/or a combination of means.

In certain embodiments, the system may employ means to communicate the responses to the collateral holder (prospective in the case of a contingent loan) in a secure environment without responders knowing extraneous information about the collateral holder and contingent upon an agreement that only certain information may be shared at the appropriate time.

In certain embodiments the system may employ means to create secure communication channels for each separate component of the system. By way of nonlimiting example, the system may employ different channels to communicate with providers of the investments from providers of the first collateral loan and/or providers of the first investment loan.

In certain embodiment the system may employ means for all of the components to be responded as a single package.

In certain embodiments providers of components may display certain parameters their components to the public without a request initiated by the collateral holder.

In certain embodiments the provider of the components may request a response from a collateral holder and the system may communicate with the collateral holder prior to direct communication with the provider of the components.

In certain embodiments sufficient information may be evaluated such that the collateral holder may, pending approval, agree to the terms of the loan.

In certain embodiments certain components may be executed through a distributed ledger transaction.

In certain embodiments the distributed ledger protocol may be based upon one of many blockchain technical means or other digital asset tracking mechanisms.

In certain embodiments the system may employ a means to execute at least the first investment loan in a currency other than the first collateral loan.

In certain embodiments the system may employ means to execute in a recognized digital currency.

In certain embodiments the system may employ a means to execute its own digital currency.

In certain embodiments the transactions may be denominated in multiple currencies.

For example, for every 2.5% return on the investments made over the loan rate may allow a borrower to save the amount of the borrower's original principal and interest payment on the first collateralized loan after the borrower paid off the First Collateralized and First Investment Loans. In another example, if the return were 5% over the loan rate, the borrower would save two times the original principal and interest amount after the first and second loans were paid off.

Turning now to FIG. 2, there is shown an embodiment of a system which is adapted for use in generating “what-if” scenarios for projecting Investment Fund Gains 2730 from investments made with a First Collateralized Loan which is in the form of a home mortgage. In this embodiment, the system provides for Graphical User Interface for Scenario Simulator 2000, in which a user enters a name of the particular scenario at 2810, a Mortgage Rate at 2820, an Investment Growth Rate at 2830, a Mortgage Type at 2840, a Principal Amount Borrowed on a First Collateralized Loan at 2050, and a Simulation Start Date at 2860, which may indicate the date upon which the First Collateralized Loan is initiated. The user then clicks on Scenario Generator Icon 2600 which initiates the generation of Investment Simulation Output at 2700, Investment Interest Expense at 2710, Investment Funds Earnings at 2720, and Investment Net Gain 2730 in a processes discussed in further detail herein. Investment Simulation Output 2700 may be in either graphical, tabular or other desired form.

In the non-limiting example of FIG. 2, Scenario Simulator 2000 provides for the collateralized property on the First Collateralized Loan as real estate property which is the subject of a 30-year fixed rate mortgage at 2840. The First Collateralized Loan (i.e. a mortgage) is in the amount of $400,000 at 2850, at an APR of 4% at 2820. This First Collateralized Loan is designated as an Accumulating Wealth Loan (“AWL” further described herein). The return on investments purchased with a First Investment Loan yield an average of a 7% return at 2830. As indicated by the scenario depicted in the Graphical User Interface of FIG. 2, the borrower may accumulate an additional Net Gain on investments purchased with the First Investment Loan of $413,000, as indicated at 2730 after the original $400,000 First Collateralized Loan is paid off over the 30 year term.

Graphical User Interface for Scenario Simulator 2000 provides additional functionality of saving the scenario generated by Simulator 2000 to a Database Server by clicking on Save Icon 2400. The scenario of FIG. 2 may be saved to the Database Server under Scenario Name 2810 in a Document Data File, and the various data generated may be stored in Data Registers corresponding to the Document Data File in processes described in further detail herein. The data associated with this scenario may then be searched for, retrieved, and made available for use by users of the system of this embodiment.

The scenario of FIG. 2 may also be deleted by clicking on Delete Icon 2500, which may remove the scenario from both the random access memory and/or the Database Server of the system. Additional functionality may include importing and/or exporting the data generated by the scenario of FIG. 2. For example, the scenario may be exported to external systems, databases and/or for use in application programs, such as for example, Excel, PowerPoint, Word, and/or other application programs.

Scenario Simulator 2000 may provide additional functionality of accessing a Home Screen through Graphical User Interface Simulator 2000 by clicking on Home Screen Icon 2100. Clicking on Screen Icon 2100 provides access to additional functionality of the system of this embodiment. Such functionality may include additional Graphical User Interfaces which permit the entry of, searching for, tracking of, processing of and/or other access to, data stored on one or more Database Servers in Document Data Files and corresponding Data Registers described herein.

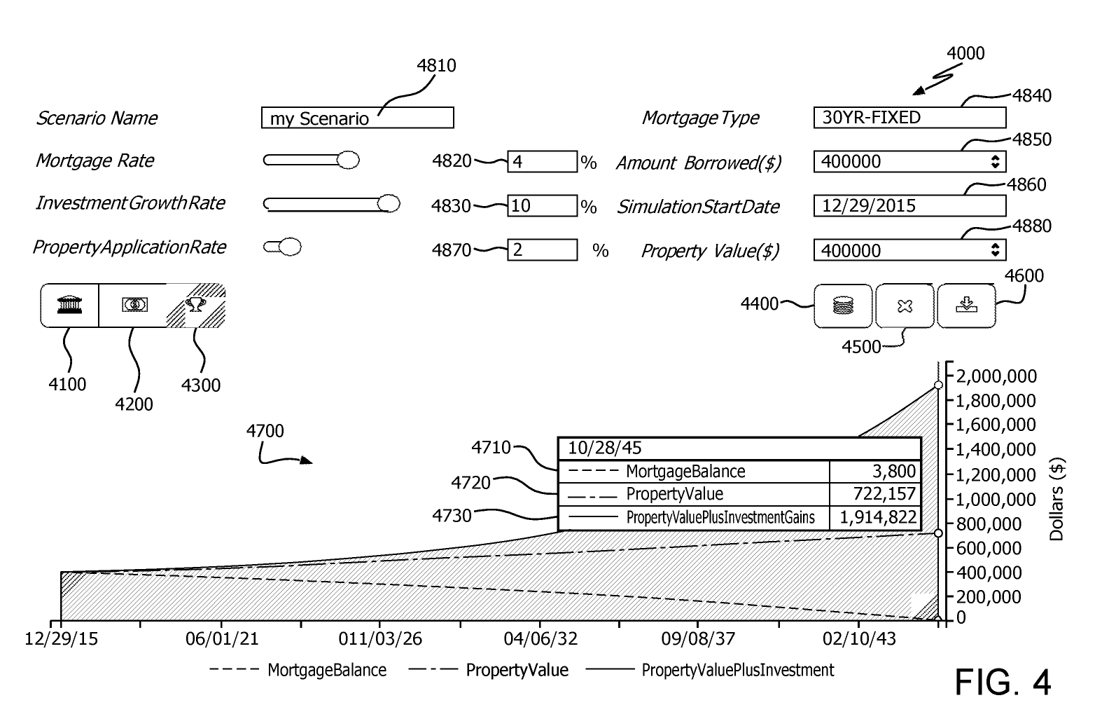

In addition, Scenario Simulator 2000 may provide additional functionality of accessing a Total Worth Scenario Screen through Graphical User Interface Simulator 2000 by clicking on Total Worth Scenario Icon 2300. Clicking on Total Worth Scenario 2300 brings the user to a Total Worth Scenario Graphical User Interface Screen, such as for example, the embodiment depicted in FIG. 4 hereto. As further described herein, FIG. 4 depicts an embodiment of a system which is adapted for use in generating “what-if” scenarios for projecting Property Value Plus Investment Fund Gains 4730 from investments made with a First Collateralized Loan which is in the form of a home mortgage. This scenario factors in the projected change in value of the underlying collateralized property over time.

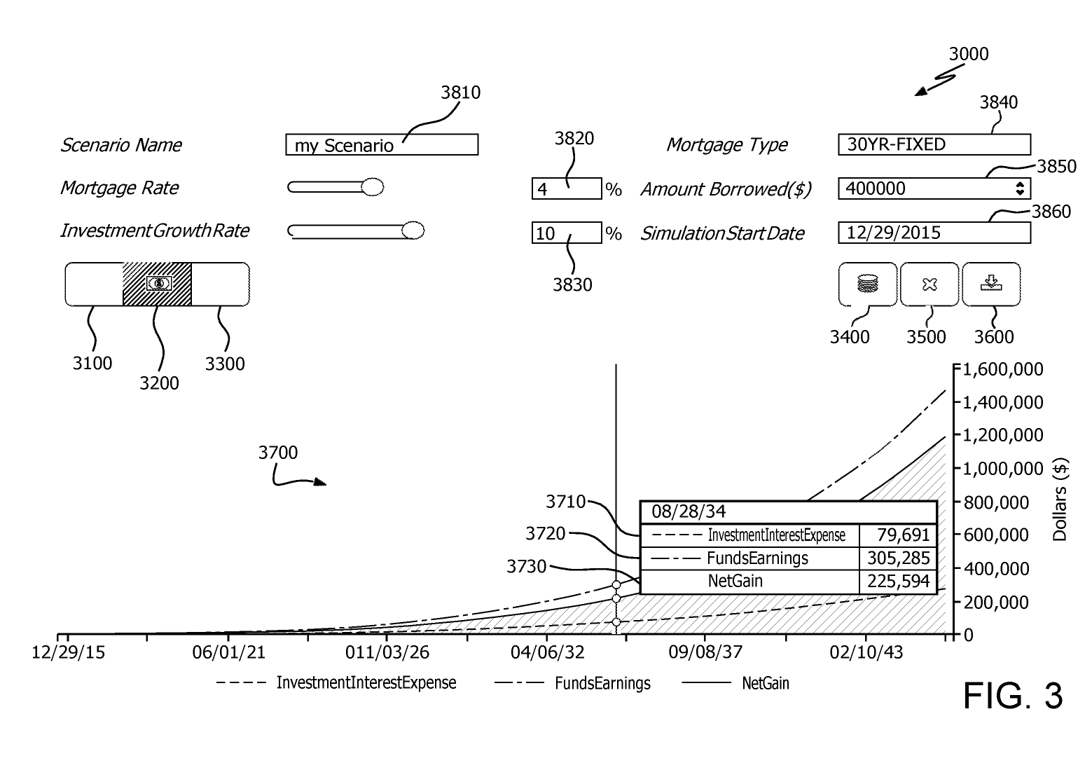

Referring now to FIG. 3, there is shown an embodiment of a system which is adapted for use in generating “what-if” scenarios for projecting Investment Fund Gains 3730 from investments made with a First Collateralized Loan which is in the form of a home mortgage. In this embodiment, the system provides for Graphical User Interface for Scenario Simulator 3000, in which a user enters a name of the particular scenario at 3810, a Mortgage Rate at 3820, an Investment Growth Rate at 3830, a Mortgage Type at 3840, a Principal Amount Borrowed on a First Collateralized Loan at 3050, and a Simulation Start Date at 3860, which may indicate the date upon which the First Collateralized Loan is initiated. The user then clicks on Scenario Generator Icon 3600 which initiates the generation of Investment Simulation Output at 3700, Investment Interest Expense at 3710, Investment Funds Earnings at 3720, and Investment Net Gain 3730 in processes discussed in further detail herein. Investment Simulation Output 3700 may be in either graphical, tabular or other desired form.

In the non-limiting example of FIG. 3, Scenario Simulator 3000 provides for the collateralized property on the First Collateralized Loan as real estate property which is the subject of a 30-year fixed rate mortgage at 3840. The First Collateralized Loan (i.e. a mortgage) is in the amount of $400,000 at 3850, at an APR of 4% at 3820. This First Collateralized Loan is designated as an Accumulating Wealth Loan (“AWL” further described herein). The return on investments purchased with a First Investment Loan yield an average of a 10% return at 3830. As indicated by the scenario depicted in the Graphical User Interface of FIG. 3, the borrower may accumulate an additional Net Gain on investments purchased with the First Investment Loan of approximately $1.2 million after the original $400,000 First Collateralized Loan is paid off over the 30 year term.

As also indicated in FIG. 3, Scenario Simulator 3000 also provides for functionality which enables a user of the system of this embodiment to determine, at any point in time, the projected Investment Interest Expense 3710, Investment Funds Earnings 3720, and Investment Net Gain on Investment 3730. In this regard, Scenario Simulator 3000 of FIG. 3 projects that, as of Aug. 28, 2034, Investment Interest Expense 3710 is expected to accumulate an amount of $79,691, Investment Funds Earnings 3720 is expected to accumulate an amount of $305,285, thereby producing an Investment Net Gain 3730 of $225,594.

Graphical User Interface for Scenario Simulator 3000 provides additional functionality of saving the scenario generated by Simulator 3000 to a Database Server by clicking on Save Icon 3400. The scenario of FIG. 3 may be saved to the Database Server under Scenario Name 3810 in a Document Data File, and the various data generated may be stored in Data Registers corresponding to the Document Data File in processes described in further detail herein. The data associated with this scenario may then be searched for, retrieved, and made available for use by users of the system of this embodiment.

The scenario of FIG. 3 may also be deleted by clicking on Delete Icon 3500, which may remove the scenario from both the random access memory and/or the Database Server of the system. Additional functionality may include importing and/or exporting the data generated by the scenario of FIG. 3. For example, the scenario may be exported to external systems, databases and/or for use in application programs, such as for example, Excel, PowerPoint, Word, and/or other application programs.

Scenario Simulator 3000 may provide additional functionality of accessing a Home Screen through Graphical User Interface Simulator 3000 by clicking on Home Screen Icon 3100. Clicking on Screen Icon 3100 provides access to additional functionality of the system of this embodiment. Such functionality may include additional Graphical User Interfaces which permit the entry of, searching for, tracking of, processing of and/or other access to, data stored on one or more Database Servers in Document Data Files and corresponding Data Registers described herein.

In addition, Scenario Simulator 3000 may provide additional functionality of accessing a Total Worth Scenario Screen through Graphical User Interface Simulator 3000 by clicking on Total Worth Scenario Icon 3300. Clicking on Total Worth Scenario 3300 brings the user to a Total Worth Scenario Graphical User Interface Screen, such as for example, the embodiment depicted in FIG. 4 hereto. As further described herein, FIG. 4 depicts an embodiment of a system which is adapted for use in generating “what-if” scenarios for projecting Property Value Plus Investment Fund Gains 4730 from investments made with a First Collateralized Loan which is in the form of a home mortgage. This scenario factors in the projected change in value of the underlying collateralized property over time.

As also indicated by FIG. 3 at 3710, 3720, and 3730, if the return is the same as it has been historically of 4%, a $400,000 AWL should net $1.2 million after the borrower pays down the original collateralized first loan in thirty years. It should be noted that, under these conditions, the borrower would be able to retire the original collateralized first year loan after only nineteen years with the same payments as a thirty year first collateralized loan.

With reference to FIG. 4, there is shown an embodiment of a system which is adapted for use in generating “what-if” scenarios for projecting Property Value Plus Investment Fund Gains 4730 from investments made with a First Collateralized Loan which is in the form of a home mortgage. This scenario factors in the projected change in value of the underlying collateralized property over time.

In this embodiment, the system provides for Graphical User Interface for Scenario Simulator 4000, in which a user enters a name of the particular scenario at 4810, a Mortgage Rate at 4820, an Investment Growth Rate at 4830, a Mortgage Type at 4840, a Principal Amount Borrowed on a First Collateralized Loan at 4050, a Simulation Start Date at 4860, which may indicate the date upon which the First Collateralized Loan is initiated, a Property Appreciation Rate at 4870, and an Initial Property Value at 4880.

The user then clicks on Scenario Generator Icon 4600 which initiates the generation of Investment Simulation Output at 4700, Mortgage Balance at 4710, Property Value at 4720, and Property Value Plus Investment Gains at 4730 in a processes discussed in further detail herein. Investment Simulation Output 4700 may be in either graphical, tabular or other desired form.

In the non-limiting example of FIG. 4, Scenario Simulator 4000 provides for the collateralized property on the First Collateralized Loan as real estate property which is the subject of a 30-year fixed rate mortgage at 4840. The First Collateralized Loan (i.e. a mortgage) is in the amount of $400,000 at 4850, at an APR of 4% at 4820. This First Collateralized Loan is designated as an Accumulating Wealth Loan (“AWL” further described herein). The return on investments purchased with a First Investment Loan yield an average of a 10% return at 4830. The Property Appreciation Rate is 2% at 4870, with an Initial Property Value of $400,000 at 4880.

As indicated by the scenario depicted in the Graphical User Interface of FIG. 4, the borrower may accumulate a total net worth on investments purchased with the First Investment Loan, plus the appreciated property value of $1,914,022 after the original $400,000 First Collateralized Loan is paid off over the 30 year term.

As also indicated in FIG. 4, Scenario Simulator 4000 also provides for functionality which enables a user of the system of this embodiment to determine, at any point in time, the projected Mortgage Balance 4710, Property Value 4720, and Total Value of the Collateralized Property and Investment Gains 4730. In this regard, Scenario Simulator 4000 of FIG. 4 projects that, as of Oct. 28, 2045, Mortgage Balance 4710 is expected to be $3,800, Property Value 4720 is expected to be $722,157, and the Property Value Plus Investment Gains is expected to be $1,914,822.

Graphical User Interface for Scenario Simulator 4000 provides additional functionality of saving the scenario generated by Simulator 4000 to a Database Server by clicking on Save Icon 4400. The scenario of FIG. 4 may be saved to the Database Server under Scenario Name 4810 in a Document Data File, and the various data generated may be stored in Data Registers corresponding to the Document Data File in processes described in further detail herein. The data associated with this scenario may then be searched for, retrieved, and made available for use by users of the system of this embodiment.

The scenario of FIG. 4 may also be deleted by clicking on Delete Icon 4500, which may remove the scenario from both the random access memory and/or the Database Server of the system. Additional functionality may include importing and/or exporting the data generated by the scenario of FIG. 4. For example, the scenario may be exported to external systems, databases and/or for use in application programs, such as for example, Excel, PowerPoint, Word, and/or other application programs.

Scenario Simulator 4000 may provide additional functionality of accessing a Home Screen through Graphical User Interface Simulator 4000 by clicking on Home Screen Icon 4100. Clicking on Screen Icon 4100 provides access to additional functionality of the system of this embodiment. Such functionality may include additional Graphical User Interfaces which permit the entry of, searching for, tracking of, processing of and/or other access to, data stored on one or more Database Servers in Document Data Files and corresponding Data Registers described herein.

In addition, Scenario Simulator 4000 may provide additional functionality of accessing an Investment Valuation Simulation Screen, such as, for example, Graphical User Interface for Scenario Simulators 2000 and/or 3000 of FIG. 2 and FIG. 3, respectively, by clicking on Investment Valuation Scenario Icon 4300. Clicking on Investment Valuation Scenario Icon 4300 brings the user to an Investment Valuation Simulation Screen, such as for example, the embodiments depicted in FIGS. 2 and/or 3 hereto. Embodiments depicted in FIG. 2 and FIG. 3 also may comprise Investment Valuation Scenario Icons (shown as Icons 2300 and 3300, respectively), and which may provide similar functionality to that of Investment Valuation Scenario Icon 4300.

FIG. 4 further depicts an embodiment of the Graphical User Interface adapted for use with a first collateralized loan which is in also the form of a home mortgage. In this example, the collateralized property is real estate property which is the subject of a 30-year fixed rate mortgage. The first collateralized loan (i.e. mortgage) is in the amount of $400,000 at an APR of 4%. This first collateralized loan is designated as an AWL. The return on investments purchased with a second investment loan yield and average of 10% return. As indicated by the graphical user interface of FIG. 4 the borrower will accumulate an additional net of $1,192,665 after the original $400,000 first collateralized loan is paid off over the 30 year term.

Factoring in the performance of second investment loans with the appreciation of the collateralized real estate itself, and assuming an historical long-term average real estate appreciation of 2%, and combine it with the accumulation of the investments based upon the second loans returning 10%, the equity accumulated in the collateralized real property, plus the accumulated investment returns based upon the second investment loans, will be worth $1.9 million in thirty years.

In certain embodiments of this invention, additional revenue is generated by converting implied assets that the borrower builds through the principal and interest payments on the first collateralized loan, and converting them to real assets at the borrowing rate on the first collateralized loan. Then, these implied assets are invested in other asset classes returning more than the cost of investment vehicles invested in.

The system in an embodiment may be configured to leverage existing debt instruments and market mechanisms, and integrate investment methodologies with funding, tracking, and an execution mechanism inserted within the lending and asset management product structure. Each entity contributes distribution and products into the package. In an embodiment, the borrower/collateralized property owner may be required to use a Graphical User Interface (such as, for example, the User Interface Systems or other Graphical User Interfaces described in further detail herein) to manage the initiation and/or payments of the Collateralized and Investment Loans as well as investments made through an AWL Management Module (described in further detail herein).

When a First Collateralized Loan associated with the system of an embodiment is originated, it may be categorized as an Accumulating Wealth Loan (“AWL”). Both conventional and AWL Loans are originated by existing market participants through existing distribution channels. One difference is that an AWL may be flagged as an AWL at the agency through the loan origination process. Both the conventional and the AWL Loans may be entered into the same agency buying program (e.g Fannie Mae).

The agency may warehouse segments and aggregate AWL identified Loans. The agency may then create AWL related securities as well as securities from the conventional loans. The conventional loans may be sold to various fund investors into a well-established marketplace for these securities. The AWL Loans may be priced by the same process, but may be made available to an AWL Fund through an AWL Funding and Lending Module (described in further detail herein) at observable market rates. AWL Securities may be purchased through the AWL Funding and Lending Module from the agency which may be held at the AWL Fund broker-dealer.

As principal and interest payments are made on the First Collateralized One, the securities may receive those payments from the servicer into the AWL Fund's account at its broker-dealer. As each principal and interest payment is received, the AWL Funding and Lending Module may execute the terms of an Investment Loan, and loan the amount of the Collateralized Loan principal and interest payment back to the borrower through the Management Module.

The AWL Management Module of the system of an embodiment may be adapted to manage the cash flows between the AWL Funding and Lending Module, the borrower, and the investments fund accounts containing the investments made by the borrower from within an Investment Management Module (described in further detail herein). The Investment Management Module, which may be separate or part of the AWL Management Module, may maintain relationships with multiple third-party entities, such as, by non-limiting example, asset and/or security investment entities.

In an embodiment, the AWL Funding and Lending Module may be accessed through a Graphical User Interface on a permission basis by the lending partners and the investment partners as links within their electronic platforms. Access to certain third-party products would be permissioned by each partner in accordance with the access point on the AWL Funding and Lending Module.

In an embodiment, the AWL Management Module may offer borrowers the ability to analyze the offerings from each of the product providers based on current and historical performance of the products.

The AWL Management Module may allow borrowers to create multiple what-if scenarios with multiple combinations of products to visually show how the AWL may perform under user-defined scenarios, such as those depicted in FIGS. 2, 3 and 4.

The AWL Management Module may also combine projected future performance to complete the analysis of thirty years of compounding growth. The AWL Management Module may show the quantitative and graphical historical performance of the package using each selected product within this scenario. The AWL Management Module may also offer the ability to define the composition of the package and execute the package from within the Investment Management Module. The Investment Management Module may also carry out such functionality independent of or in communication with the AWL Management Module.

The AWL Funding and Lending Module (as further described herein) may facilitate the cash flows by receiving the principal and interest cash flow loan amounts from the AWL Fund and establishing borrower level accounts with the investment managers. The AWL Funding and Lending Module may use the cash flows to execute the investments directly with the investment managers for the benefit of the borrower account. The AWL Funding and Lending Module may also execute, track, manage, and settle the obligation of the second loan with the borrower.

The AWL Funding and Lending Module may partner with a Web Bank which may make the Investment Loans based on a schedule of principal and interest payments made or to be made on the Collateralized Loan. The AWL Funding and Lending Module may receive funding from the AWL Fund to make the loan, and may purchase the loan from a Web Bank with the funds provided by the AWL Fund through the AWL Funding and Lending Module. The AWL Funding and Lending Module may be responsible for affecting prearranged settlement of the Investment Loans with the AWL Fund. The AWL Fund may sell the Investment Loans through the AWL Funding and Lending Module to a third party and satisfy its obligations.

The AWL Fund may be a large but straightforward fund, and be run as a conventional mortgage securities fund. The AWL Fund may purchase specified pools of First Collateralized Loans, such as mortgages, based upon the premise that the AWL Fund may pay for such securities through its broker. AWL Fund's broker may hold the securities and charge all the cost of funds for purchasing the securities. AWL Fund's broker may also lend principal and interest cash flows on a secured basis and matched basis. Due to the nature of the AWL Fund, the analytics and the risk management of the fund may be executed on a loan level, but also on a cash flow and primarily matched basis.

While the AWL Fund may be primarily a matched portfolio, the AWL Fund may utilize an industry-standard mortgage trading system employing the valuation methodology with real-time risk marked to market on a daily basis, and stress tested on a weekly basis, with independent marks on a monthly basis.

While the AWL Fund utilizes cash flows from specific securities, and positions them for long-term returns, the AWL Fund may manage interest rate and convexity risk with other generic and very liquid securities. AWL Funds may generate returns based primarily on the relationship between LIBOR and the fixed rate on the original collateralized and second investment loans.

The AWL Fund and the AWL funding and lending modules may exist within a single entity offering an investor in the entity blended returns composing at least partially from the “Fund”, borrowing, lending, and investment activities.

Turning now to FIG. 5, an embodiment is shown of Networked System 5000 comprising Database Server 5010 in operative communication with User Interface Systems 5310, 5320, 5330, and 5340 through Network 5200. Database Server 5010 may host Document Data Files and corresponding Data Registers such as, for example, those depicted in FIG. 1.

User Interface Systems 5310, 5320, 5330, and 5340 may comprise desktop computers, laptop computers, portable computing devices, terminals, or any other suitable input/output device which allows access to and interaction with Database Server 5010. It should be noted that any number of User Interface Systems may be employed to provide access and interaction with Networked System 5000.

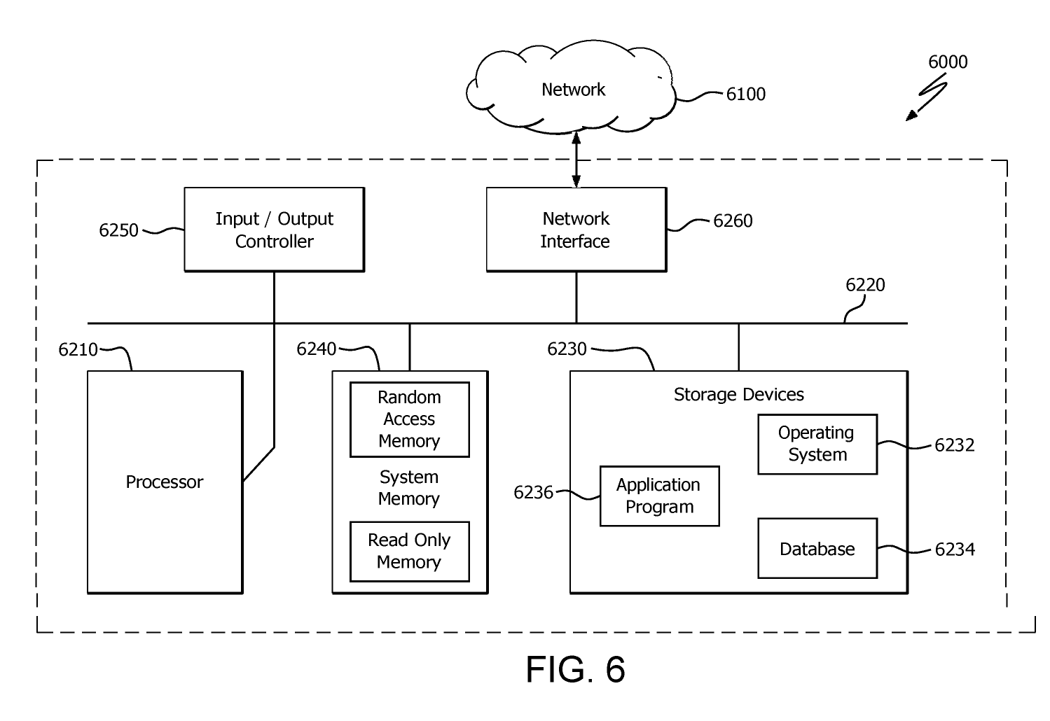

Database Server 5010 may be connected to Network 5200 using a network connection device such as, for example, Network Interface 6260 of FIG. 6. The network connection device may connect to, for example, a local area network (LAN) or a wide area network (WAN) at 5200. This allows for multiple end users, with appropriate permissions, to access Database Server 5100 to input, retrieve, search, and/or process data, initiate and/or manage loans and loan payments, initiate and/or manage investments, and/or create, documents and/or reports and otherwise utilize the functionality of the system via User Interface Systems 5310, 5320, 5330, and 5340.

By way of specific example, a user may operate one of User Interface Systems 5310, 5320, 5330, and 5340 to determine the present amount of principal and interest payments which have been made on a First Collateralized Loan and which are available for initiating a First Investment Loan, initiate a First Investment Loan in the amount of available principal and interest on the First Collateralized Loan, select, purchase, sell, track and/or purchase the Investment Vehicles which are to be invested in with the proceeds of the First Investment Loan, run “what-if” scenarios on asset performance, save data to and retrieve data from Database Server 5100, and/or generate and distribute reports related to any of the foregoing.

The user may send this data via Network 5200, such that it is received by Database Server 5100 that stores such data in Document Data Files and corresponding Data Registers. Database Server 5100 may receive such data sent via at least one of User Interface Systems 5310, 5320, 5330, and 5340 and stores and/or processes such data in accordance with the foregoing. Database Server 5100 may then export such data to any of User Interface Systems 5310, 5320, 5330, and 5340 from which a request is made. Database Server 5100 may also compile such data into documents, reports, or other output comprising such data in accordance with data parameters received from a User Interface System, prior to transmitting such output over Network 5200 to a requesting User Interface System.

In an embodiment, a Graphical User Interface associated with a User Interface System which provides access to Database Server 5100 may be implemented in an automated or semi-automated system using appropriate circuitry and components programmed according to the various embodiments. While various other circuits, circuitry or components may be utilized in computing devices utilized for such special purposes, an example illustrated in FIG. 6 includes System 6000 which may be implemented, for example, in laptop, desktop or other computing platforms. Circuitry 6200 may be used in a device that implements real-time access, processing, tracking, maintenance and reporting of data, as described herein, such as a computing device used by property owners, investors, lenders and other parties for the optimal management and investment of collateralized assets.

Turning back to the embodiment of FIG. 6, Storage Device 6230 may include software such as AWL Management Module System Application Program 6236 that may be run or executed by one or more Processors 6210 according to an Operating System 6232. Circuitry 6200 may provide that Processor 6210 loads Operating System 6232, and thereafter Application Program 6236 (e.g., into Memory 6240). Alternatively, or in addition, Database Server 5100 may be accessed via a Web-Based application.

System 6200 may include Network Interface 6260 facilitating communications with other devices, e.g., a connection to other devices over Network 6100 using components such as a WWAN transceiver, a WLAN transceiver or a wired connection, e.g., a LAN connection. In an embodiment, System 6200 may include Input/Output Controller 6250 for data input and display. System 6200 may also include various Memory 6240 and Storage Devices 6230, for example Database 6234, e.g., for storing Document Data Files and corresponding Data Registers, as well as associated data, referred to herein.

Device circuitry, such as the embodiment depicted in FIG. 6, may be used in a device that implements real-time access, processing, tracking, maintenance and reporting of data, as described herein, such as a computing device used by property owners, investors, lenders and other parties for the optimal management and investment of collateralized assets in a centralized database. It will also be apparent that circuitry other than the non-limiting example of FIG. 6 may be used.

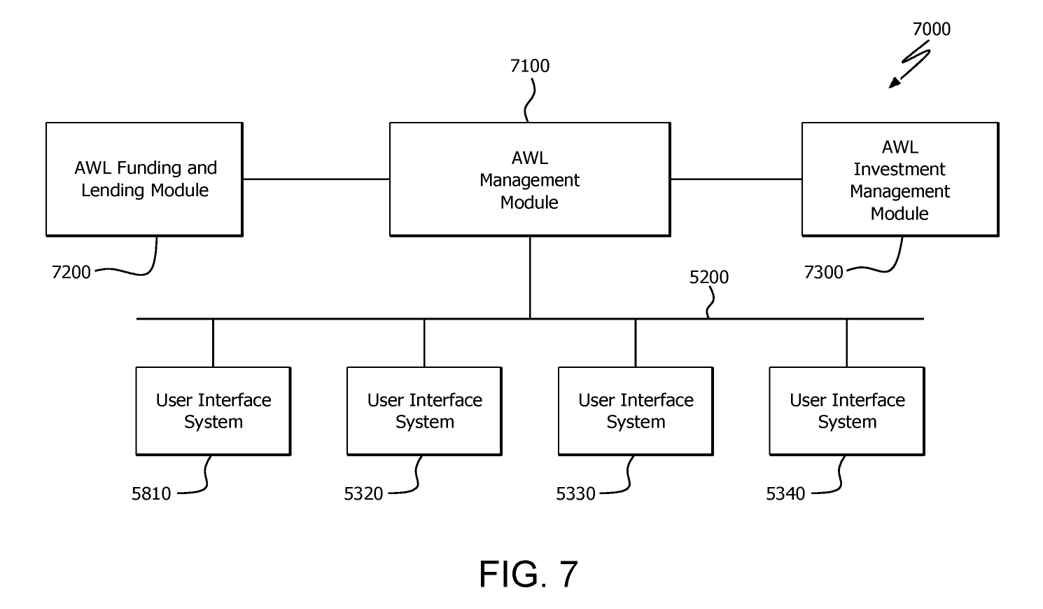

Turning now to FIG. 7, there is shown an embodiment of AWL Management System 7000, which is accessed by or through a Database Server, such as, for example, Database Server 5100 shown in FIG. 5. AWL Management System 7000 may comprise AWL Management Module 7100. In an embodiment, AWL Management System 7000 may further comprise and/or otherwise be in operative communication (e.g. over a Network such as Network embodiments described herein) with AWL Funding and Lending Module 7200, and/or AWL Investment Management Module 7300.

In one or more embodiments, AWL Management Module 7100 may comprise at least the same or similar functionality as the AWL Management Module functionality described above. Similarly, in one or more embodiments, AWL Funding and Lending Module 7200 may comprise at least the same or similar functionality as the AWL Funding and Lending Module functionality described above. Likewise, in one or more embodiments, AWL Investment Management Module 7300 may comprise at least the same or similar functionality as the AWL Investment Management Module functionality described above.

AWL Management System 7000, AWL Management Module 7100, AWL Funding and Lending Module 7200 and/or AWL Investment Management Module 7300 may be accessed by users through User Interface Systems 7410, 7420, 7430, and 7440, or any number of User Interface Systems required by users. In an embodiment, User Interface System 7410, 7420, 7430, and 7440 may comprise at least the same or similar functionality as User Interface Systems 5210, 5220, 5230, and 5240.

Users, having various levels of permissions to use certain functionality of AWL Management System 7000, may therefore access the permitted functionality of AWL Management System 7000 through one or more of the User Interface Systems. Thus, authorized users may create, access, manage, and process Document Data Files and corresponding Data Registers, and generate Master Documents through a Document Generator via the Database Server and/or through AWL Management Module 7100, as well as originate, manage, search, track, and make payments on Collateralized and Investment Loans through AWL Management Module 7100.

Similarly, authorized users may access the permitted functionality of AWL Funding and Lending Module 7200 through one or more of the User Interface Systems. Thus, authorized users may interact with the AWL Broker Dealer, the AWL Fund, as well as the AWL Lending Module.

Likewise, authorized users may access the permitted functionality of AWL Investment Management Module 7300 through one or more of the User Interface Systems. Thus, authorized users may originate, manage, search, track, trade portfolio investment vehicles, create, store, process “what-if” scenarios, and otherwise manage an investment portfolio maintained on AWL Investment Management Module 7300. In addition, authorized users of AWL Investment Management Module 7300 may also include investment vehicle portfolio managers, investment companies, analysts, administrators and other authorized users.

In certain embodiments, the mortgage lending and investment platform (hereinafter the “Platform”) disclosed herein begins with a mortgage made to a homeowner by a lender, secured by a security interest in the homeowner's home as collateral for the loan. A mortgage in the Platform may be designated as an AWL mortgage at the lender. Similar to a conventional mortgage, the AWL-designated mortgage may then be sold into an agency-buying program. The applicable entity/agency may then warehouse, segment and aggregate all or a portion of AWL-identified mortgages and create AWL securities. A sponsoring party may then enter into an agreement with the agency to purchase AWL mortgage-backed securities at market rates. An AWL fund may be raised to provide funds to purchase the AWL mortgage-backed securities from the agency and place such securities with a designated broker-dealer. Principal payments may then be made by the homeowner to the servicer, and from the servicer to the designated broker-dealer holding the AWL securities. The broker-dealer may then pass along at least a portion of the principal and interest payments to the AWL fund, and may loan a portion of the principal payments made on any borrowed securities to the sponsoring facility, based at least partially on the value of other securities held as collateral. The sponsoring party facility may also borrow cash flows based on the principal and interest mortgage payments made by the homeowner from the AWL fund and loan such principal and interest payments to the homeowner with the understanding that the funds will be invested and pledged as collateral for the loan. The principal payments may then be invested on behalf of the homeowner and managed by an asset manager.

In certain embodiments, the Platform may be broken down into six main steps. These steps include loan origination, lender transfer of mortgage to agency, agency sale of principal and interest to a sponsoring entity, loan of principal to borrower, raising fund capital and investment of principal and interest payments on behalf of borrowers. Each of these steps may contain product offerings that currently exist in some form or another in today's mortgage lending market and which are governed by existing and established regulatory regimes.

In such embodiments, the first step in the Platform embodiment may be the origination of AWL accounts with new home borrowers. This step may include two processes: (1) mortgage loan origination; and (2) securities brokerage.

In certain embodiments, mortgage loan origination may be governed by the S.A.F.E. Act, enacted on Jul. 30, 2008. The S.A.F.E. Act mandates a nationwide licensing and registration system for mortgage loan originators. Specifically, the S.A.F.E. Act requires all states to provide a licensing and registration regime for non-agency regulated mortgage loan originators, including the loan originators contemplated by the Platform. Thus, state specific licensing and registration requirements may also apply to any mortgage loan origination, depending on the jurisdiction in which such mortgage loans are originated. In addition, the S.A.F.E. Act resulted in the creation of the Nationwide Mortgage Licensing System and Registry with which every mortgage loan originator must register. For this embodiment, the sponsoring entity may consider partnering with a licensed mortgage originator to ensure compliance with the mortgage loan origination laws and requirements.

Also, included in the first step of the Platform embodiment may be a securities brokerage component because the Platform includes a securities transaction (as discussed in more detail in step six below)—a homeowner participating in the Platform may, in addition to the mortgage loan, be borrowing an additional loan of such homeowner's principal and interest payments, which may be invested by an asset manager. Securities broker-dealers are regulated by the Securities and Exchange Commission (“SEC”), Financial Industry Regulatory Authority (“FINRA”), self-regulatory organizations as well as the states. The Securities Exchange Act of 1934 (the “Exchange Act”) requires the registration of any broker-dealer effecting securities transactions by means of interstate commerce. The various states' securities laws also regulate broker-dealers within their jurisdictions and, unless an exemption is available, require registration by any broker-dealer conducting business from or with persons in the state in addition to other registration requirements. Specific to real estate brokers, there is no general exception from the broker-dealer registration requirements for licensed real estate brokers or agents who engage in the business of effecting transactions in real estate securities. For this embodiment, the sponsoring entity may consider engaging a retail broker-dealer and also ensuring complete disclosure of the entire Platform process to investors through a private placement memorandum.

In the second step of the Platform embodiment, the lender may transfer all or simply the credit component of the homeowner's mortgage to either the Federal National Mortgage Association (“Fannie Mae”) or the Federal Home Loan Mortgage Corporation (“Freddie Mac,” together with Fannie Mae, the “Agencies” and each, an “Agency”). The Agencies were created by Congress to provide liquidity, stability and affordability to the mortgage market. At times, the Agencies buy mortgages from lenders and either hold such mortgages in their portfolios or package the loans into mortgage-backed securities that may be sold. Thus, the second step of the Platform may mirror the current conventional secondary mortgage market because here, the Platform's lender may sell the homeowner's mortgage to the Agencies and be subject to regulation by Federal Housing Finance Agency. Given that the second step falls within the scope of the conventional mortgage securities buying scheme, the sponsoring entity may only follow the ordinary course transfers that occur between the Agencies and investors in mortgage-backed securities.

In the third step of the Platform embodiment, the applicable Agency may sell the principal and interest related to the homeowner's mortgage to the sponsoring entity, either directly or through the originator of the loan. As discussed in the second step, the Agencies currently participate in the secondary mortgage market by packaging purchased mortgage loans into mortgage-backed securities that are then sold to investors and third parties either directly or through “swap and sell” transactions with originators of the loans. Such mortgage securities products may take various forms. The Agencies' sales of the mortgage-backed securities to the sponsoring entity may fall within the scope of the Agencies' current mortgage product offerings and would be regulated by Federal Housing Finance Agency. Therefore, as in step two, the third step of the Platform embodiment may also fall within the scope of the conventional mortgage securities buying scheme. However, the sponsoring entity may need to raise capital to purchase such mortgage securities from the Agencies or originators, potentially by using investment funds or other capital sources.

In the fourth step of the Platform embodiment, the AWL fund may be raised through a securities offering exempt from registration with the SEC (the “Private Placement”). The Private Placement will need to comply with the Regulation D of the Securities Act of 1933 (the “Securities Act”). In order to qualify as an offering exempt under the Securities Act, certain limitations may apply to the offering, including, but not limited to, that the investment must be restricted to qualified purchasers or 100 investors as well as restrictions on resale. In addition, the AWL fund must comply with the provisions of the Investment Company Act of 1940 (the “1940 Act”) or be exempt from registration as an investment company pursuant to an exception or exemption to the 1940 Act. Certain private funds are excluded from the definition of an investment company and exempt from registration. Private placements are also subject to the antifraud provisions of securities laws. In addition to raising the AWL fund, the sponsoring entity may also want to consider obtaining additional capital in the form of leverage.

In the fifth step of the Platform embodiment, the sponsoring entity lending facility may make or cause to be made a secured loan to the homeowner for a portion of the amount of the principal payment on the homeowner's mortgage. A participant in the consumer lending industry may be subject to a wide range of federal laws and regulations. The responsibility for overseeing compliance with federal consumer laws and regulations falls primarily, though not exclusively, to the Bureau of Consumer Financial Protection (“CFPB”). The CFPB has rulemaking, supervisory and enforcement authority over non-depository institutions engaged in, among other things, mortgage-related activities. In order to ensure compliance with the consumer lending laws and regulations, sponsoring entity may consider using a partner bank or filing for a lending license. Certain states may allow lending without a license, but restrictions exist on the rates that may be charged and amounts offered to consumers.

In the sixth and final step of the Platform embodiment, the asset manager may invest the homeowner's principal payments and interest on behalf of the borrower/homeowner. This implicates two sub-processes: (i) securities brokerage; and (ii) investment management. The regulatory framework for securities brokerage as discussed above in step one also applies here. To comply with such regulatory requirements, sponsoring entity may use the same securities broker-dealer engaged in step one to administer the borrowers' accounts.

The investment management component of this sixth and final step is subject to compliance with the Investment Advisers Act of 1940 (the “Advisers Act”). Under the Advisers Act, investment advisers must register with the SEC or qualify for exemption from the registration requirement. In order to comply the with the Advisers Act, the Total Worth facility will be required to register as an exempt reporting advisor (when the assets under the facility's management are $25 million) or as an investment adviser (when the assets under the facility's management are $150 million).

Various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Exemplary embodiments are described herein with reference to the figures, which illustrate examples, methods, devices and program products according to various exemplary embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It should also be noted that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative exemplary embodiments have been described herein with reference to the accompanying figures, it is to be understood that this description is not limiting, and that various other changes and modifications may be affected therein by one skilled in the art without departing from the scope or spirit of the disclosure.

What is claimed is:

1. A computer implemented, non-transitory, networked system having a graphical user interface in operative communication with a database for valuing, utilizing and displaying to a user in real-time current values of collateralized property owned by an owner and for monetizing unrealized value of said values of said collateralized property, said system comprising:
one or more databases for storing in registers associated with said one or more databases, one or more of a value equal to an amount of available principal and interest from principal and interest paid against a first loan collateralized by said property, and a value equal to an amount of available funds of a second investment loan, and wherein said available amount of funds of said second investment loan is based upon said principal and interest paid against said first collateralized loan;
a management module in operative communication with said one or more databases;
a display providing a graphical user interface in operative communication with said management module that permits access by a user of said system to said management module, via said graphical user interface;
wherein said graphical user interface comprises one or more icons for indicating a selection of one or more investment vehicles; and
a processor that, responsive to user interaction with said one or more investment vehicle icons, opens a data field for indicating one or more of an amount of said one or more investment vehicles which are to be purchased by said user, wherein said graphical user interface provides a function for executing a purchase of said amount of said one or more investment vehicles utilizing at least a portion of said funds available from said second investment loan.

2. The system of claim 1, wherein said graphical user interface further comprises an icon which when actuated opens a new graphical user interface for performing simulated projections based upon data contained in registers maintained in said database.

3. The system of claim 1, wherein said one or more databases for storing in registers associated with said one or more databases, further comprises a value equal to an amount of principal and interest paid against a first loan collateralized by said property.

4. The system of claim 1, wherein said available amount of principal and interest of said second investment loan is made available in a series of second investment loans, each such second investment loan issued in an amount equal to a principal and interest payment paid against said first collateralized loan.

5. The system of claim 1, wherein said function for executing said purchase of said amount of said one or more investment vehicles comprises accessing via said processor said database register containing said value of said available principal and interest of said second investment loan, deducting from said value of said available principal and interest of said second investment loan a purchase price associated with said purchase of said amount of said one or more investment vehicles, and overwriting said value of said available principal and interest of said second investment loan contained in said register with a value of said available principal and interest of said second investment loan remaining after said execution of said purchase of said one or more investment vehicles is completed.

6. The system of claim 1, further comprising a register in said one or more databases in which a total value of purchased investment vehicles is stored.

7. The system of claim 5, further comprising a register in said one or more databases in which a minimum value of purchased investment vehicles is stored.

8. The system of claim 6, wherein said processor compares said value stored in said register containing said total value of purchased investment vehicles, to said value stored in said register containing said minimum value of purchased investment vehicles, and wherein said total value of said purchase investment vehicles is less than said minimum value of said purchased investment vehicles, said system transmits a signal to commence a process to call said one or more second investment loans.

9. The system of claim 1, wherein said graphical user interface further comprises one or more icons for indicating a selection of analytical investment tools.

10. The system of claim 8, wherein said processor is responsive to user interaction with said one or more analytical investment tool icons.

11. The system of claim 9, wherein said user interaction with said one or more analytical investment tool icons provides user access to analytical investment tools.

12. The system of claim 10, wherein said analytical investment tools comprise one or more of information related to investment vehicle offerings, historical investment data, “what-if” scenario building tools, and investment vehicle performance projection tools.

13. The system of claim 1, wherein said one or more investment vehicles comprises one or more securities.

14. The system of claim 1, wherein said one or more investment vehicles comprises one or more AWL securities.

15. The system of claim 1, further comprising an investment management module in operative communication with said one or more databases.

16. The system of claim 1, wherein an investment management module is in operative communication with said management module.

17. The system of claim 1, further comprising a funding and lending module in operative communication with said one or more databases.

18. The system of claim 1, wherein a funding and lending module is in operative communication with said management module.

19. The system of claim 1, further comprising one or more user interface systems in operative communication with said one or more databases.

20. The system of claim 1, further comprising one or more user interface systems in operative communication with said management module.
